(19) United States
(12) Patent Application Publication
(10) Pub. No.: US 2008/0036978 A1
(43) Pub. Date: Feb. 14, 2008

(54) PROJECTING APPARATUS AND THERMAL CONTROLLING MODULE THEREOF

(75) Inventors: Tzu-Huan Hsu, Taoyuan County (TW); Chien-Ming Lee, Taipei County (TW); Tsung-Hsun Wu, Taoyuan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: BENQ CORPORATION, Taoyuan Shien (TW)

(21) Appl. No.: 11/463,315

(22) Filed: Aug. 9, 2006

(51) Int. Cl. G03B 21/16

(52) U.S. Cl. 353/85; 353/52

(57) ABSTRACT

A projecting apparatus includes a power, a lamp, and a thermal controlling module. The lamp is energized from the power. The thermal controlling module includes a blower, an air duct, and a thermal break. The blower and an air duct, which connects the lamp and the blower, are for making and directing airflow through the lamp. The thermal break is electrically connected to the power and the lamp, and is disposed on the air duct and positioned adjacent the lamp. When the temperature in the projecting apparatus exceeds a predetermined value, the thermal break becomes a turnoff so as to allow the projecting apparatus to be shut off.

### BACKGROUND OF THE INVENTION

1. Field of the Invention

The invention relates in general to a projecting apparatus, and more particularly to a projecting apparatus with a thermal controlling module.

2. Description of the Related Art

One of the major issues of the projector is the temperature control, including heat-dissipation and self-interruption mechanism. Conventional projector has a thermal break, which is disposed on the housing and positioned above the lamp. Air heated by the lamp rises or heat radiates and reaches the thermal break. The thermal break senses the change in temperature and transforms into turnoff when the temperature detected by the thermal break exceeds a predetermined temperature. The self-interruption mechanism responding to temperature protects other elements in the projector from being damage by heat or even fire.

However, the self-interruption mechanism is over-sensitive, which often occurs because of minor temperature disturbance. Users would be confused with the frequent and sudden shot down. In addition, the sensitivity of the self-interruption mechanism is greatly deteriorated if the projector is not regularly positioned, especially positioned upside down. It decreases the stability of the projector and limits the using method.

### SUMMARY OF THE INVENTION

In view of the foregoing, it is an object of the present invention to provide a projecting apparatus with a thermal controlling module capable of responding the temperature in the projecting apparatus accurately and immediately.

The invention achieves the above-identified object by providing a projecting apparatus comprising a power, a lamp, a blower, an air duct, and a thermal break. The lamp is energized from the power. The blower and the air duct, which connects the lamp and the blower, are for making and directed airflow through the lamp. The thermal break is electrically connected to the power and the lamp, and is disposed on the air duct and positioned adjacent the lamp. When the temperature in the projecting apparatus exceeds a predetermined value, the thermal break becomes a turnoff so as to allow the projecting apparatus to be shut off.

The invention achieves the above-identified object by providing a thermal controlling module for a projecting apparatus. The projecting apparatus includes a power and a lamp energized therefrom. The thermal controlling module comprises a blower, an air duct, and a thermal break. The blower and an air duct, which connects the lamp and the blower, are for making and directing airflow to the lamp. The thermal break is electrically connected to the power and the lamp, and disposed on the air duct and positioned adjacent the lamp when the temperature in the projecting apparatus exceed a predetermined value, the thermal break becomes a turnoff so as to allow the projecting apparatus to be shut off.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG.1 is a partial view of a projecting apparatus according to the preferred embodiment of the invention.

FIG. 2 is another view of the thermal controlling module in FIG. 1.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

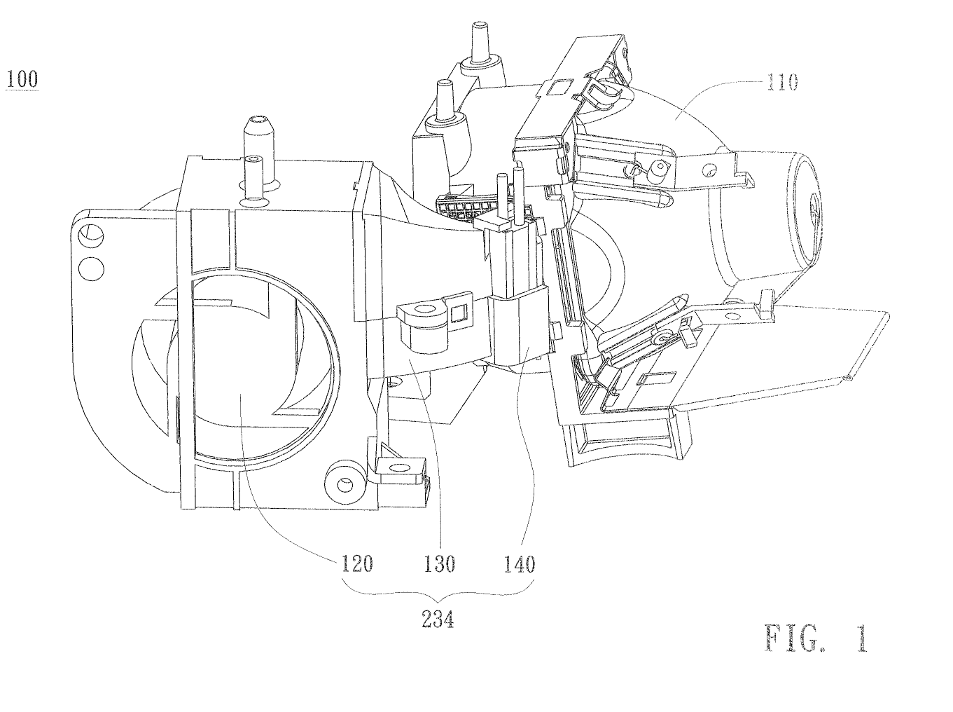

Referring to FIG. 1, which is a partial view of a projecting apparatus according to the preferred embodiment of the invention. The projecting apparatus 100 includes a power, a lamp 110, and a thermal controlling module 34. The lamp 110 is energized from the power (not shown).

The thermal controlling module 234 includes a blower 120, an air duct 130, and a thermal break 140. The air duct 130 connects the lamp 110 and the blower 120, and the thermal break 140 and the air duct 130 are for making and directed airflow through the lamp 110. Heat generated by the lamp 110 can be exchanged to airflow and dissipated to outside, and temperature in the projector will be kept within workable range. The thermal break 140 is electrically connected to the power and the lamp 110. Electronic or mechanical thermal break 140 can both be applied to the present invention. When the temperature in the projecting apparatus 100 exceeds a predetermined value, the thermal break 140 becomes a turnoff so as to allow the projecting apparatus 100 to be shut off The power therefore will not energize the lamp, major heat source in the projecting, so that the projecting apparatus can be cooling down immediately and efficiently. It protects the projecting apparatus from being damaged by high temperature or even avoids a fire.

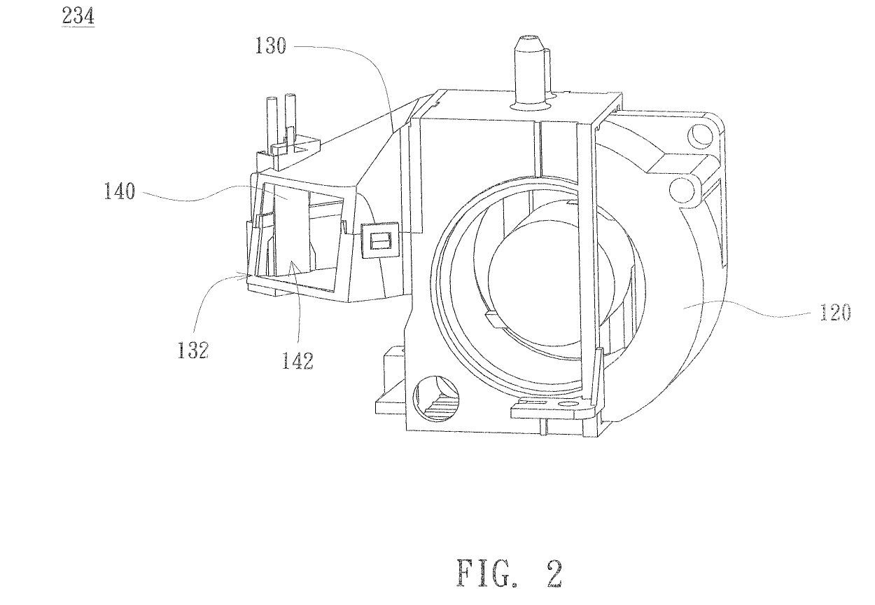

The location at which the thermal break 140 positioned is vital to its sensitivity and the capacity to thermal control of the thermal controlling module 234. Referring to FIG. 1, the thermal break 140 is disposed on the air duct 130 and positioned adjacent the lamp 110. FIG. 2 is another view of the thermal controlling module in FIG. 1. The air duct 130 has a narrow portion, as so-called nozzle 132, which is attached to the lamp 110, and the thermal break 140 is positioned at the nozzle. Preferably, the thermal break 140 is disposed on the sidewall of the air duct 130, and exposes to the inner wall of the air duct 130. The thermal break 140 is so close to the lamp 110 that response the temperature immediately. In addition, when the projecting apparatus is in operation, airflow passes through the air duct 130 so as to cause lower temperature than any other position which is equidistant from the lamp. The thermal break disposed as stated below is characterized by great difference in temperature between the operation and over-heat condition of the thermal break. The thermal break accurately reacts responding to temperature of the lamp, and will not become a turnoff because of minor disturbance in temperature.

The thermal break 140 is preferably positioned at the horizontal which is substantially equidistant from upper and lower edges of the lamp 110. It keeps the sensitivity of the thermal controlling module 234 substantially the same when the projecting apparatus 100 is positioned upside down.

Also, the thermal break 140 is covered by a metal layer 142; preferably the metal layer 142 includes copper. The metal layer 142 covering the thermal break improves the thermal conductivity so as to speed up the reaction of the thermal break responding to the change in temperature of the lamp.

As described hereinbefore, the projecting apparatus with the thermal controlling module of the present invention has many advantages. The thermal controlling module protects the projecting apparatus from being damaged by high temperature or even avoids a fire. Also, the thermal break disposed on the air duct and adjacent the lamp is characterized by great difference in temperature between the operation and over-heat condition of the thermal break. The thermal break therefore reacts responding to temperature of the lamp immediately and accurately. Further, even when the projecting apparatus 100 is positioned upside down, the thermal controlling module remains efficiently and sensitive as the same as usual.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A projecting apparatus comprising:
a power;
a lamp energized from the power;
a blower and an air duct, which connects the lamp and the blower, for making and directed an airflow through the lamp; and
a thermal break electrically connected to the power and the lamp, disposed on the air duct and positioned adjacent the lamp;
wherein when the temperature in the projecting apparatus exceeds a predetermined value, the thermal break becomes a turnoff so as to allow the projecting apparatus to be shut off.

2. The projecting apparatus according to claim 1, wherein the thermal break is positioned at the horizontal which is substantially equidistant from upper and lower edges of the lamp.

3. The projecting apparatus according to claim 1, wherein the thermal break is disposed on the sidewall of the air duct.

4. The projecting apparatus according to claim 1, wherein the thermal break exposes to the inner wall of the air duct.

5. The projecting apparatus according to claim 1, wherein the thermal break is covered by a metal layer.

6. The projecting apparatus according to claim 5, wherein the metal layer comprises copper.

7. A thermal controlling module for a projecting apparatus, the projecting apparatus comprising a power and a lamp energized therefrom, the thermal controlling module comprising:
a blower and an air duct, which connects the lamp and the blower, for making and directing an airflow through the lamp; and
a thermal break electrically connected to the power and the lamp, disposed on the air duct and positioned adjacent the lamp;
wherein when the temperature in the projecting apparatus exceeds a predetermined value, the thermal break becomes a turnoff so as to allow the projecting apparatus to be shut off.

8. The projecting apparatus according to claim 7, wherein the thermal break is positioned at the horizontal which is substantially equidistant from upper and lower edges of the lamp.

9. The projecting apparatus according to claim 7, wherein the thermal break is disposed on the sidewall of the air duct.

10. The projecting apparatus according to claim 7, wherein the thermal break exposes to the inner wall of the air duct.

11. The projecting apparatus according to claim 7, wherein the thermal break covered by a metal layer.

12. The projecting apparatus according to claim 11, wherein the metal layer comprises copper.
